(19) United States
(12) Patent Application Publication
(10) Pub. No.: US 2013/0314426 A1
(43) Pub. Date: Nov. 28, 2013

(54) GRAPHICS CARD DEVICE

(71) Applicant: HON HAI PRECISION INDUSTRY CO., LTD., New Taipei (TW)

(72) Inventor: CHIH-HUANG WU, New Taipei (TW)

(73) Assignee: HON HAI PRECISION INDUSTRY CO., LTD., New Taipei (TW)

(21) Appl. No.: 13/854,984

(22) Filed: Apr. 2, 2013

(30) Foreign Application Priority Data
May 22, 2012 (TW) 101118092

(51) Int. Cl. G09G 5/00

(52) U.S. Cl. CPC G09G 5/003
USPC 345/520

(57) ABSTRACT

A graphics card device includes a memory module, a graphic processing unit (GPU), a controller, a detection circuit, and a port. The GPU is electronically connected to the memory module and receives graphic data. The detection circuit determines a proportion of the graphics data occupying the memory module, and sends the proportion of the graphics that are occupying the memory module to the controller. The controller divides the memory module into a first storage space and a second storage space according to the determination. The first storage space stores graphic data received by the GPU, and the second storage space stores external data transmitted by the port.

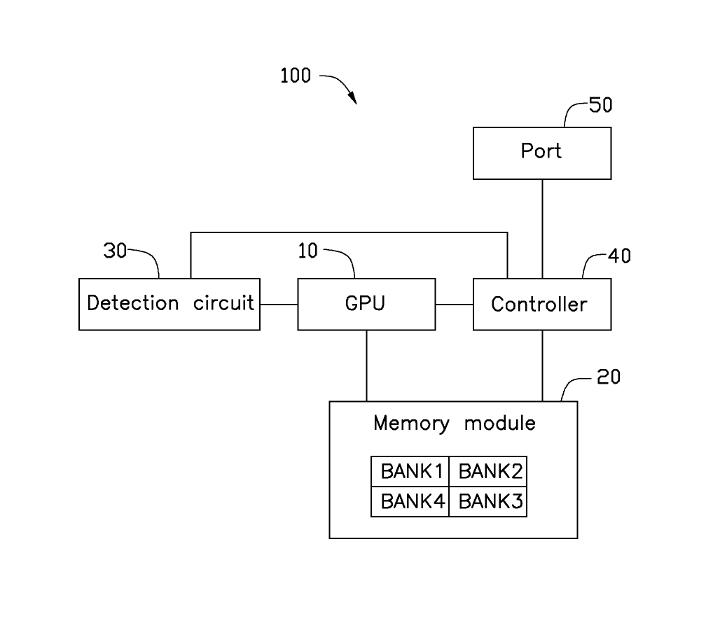

### BACKGROUND

1. Technical field

The disclosure generally relates to card devices, and particularly to a graphics card device.

2. Description of the Related Art

Many electronic devices, such as personal computers, employ a graphics card device. A storage capacity of the graphics card device can be about 2 gigabytes. However, coefficient of utilization of the storage capacity of the graphics card device is very low. For example, when users work with documents or surf the Internet, the coefficient of utilization may be below 50%. Even when the users play three dimensional games, the coefficient of utilization may not reach 70%.

Therefore, there is room for improvement within the art.

### BRIEF DESCRIPTION OF THE DRAWINGS

Many aspects of the present disclosure can be better understood with reference to the drawing. The components in the drawing are not necessarily drawn to scale, the emphasis instead being placed upon clearly illustrating the principles of the present embodiments.

The figure is a block diagram of a graphics card device, according to an exemplary embodiment.

### DETAILED DESCRIPTION

The figure shows a block diagram of a graphics card device 100 of one embodiment. The graphics card device 100 can be used in a personal computer or other electronic devices. In one exemplary embodiment, the graphics card device 100 includes a graphic processing unit (GPU) 10, a memory module 20, a detection circuit 30, a controller 40, and a port 50. The GPU 10, the memory module 20, the detection circuit 30, the controller 40, and the port 50 are all integrated on a printed circuit board (not shown).

The GPU 10 receives a variety of graphics data from a motherboard (not shown) of the electronic device, the graphics data can be three dimensional (3D) graphics or other data, for example. The GPU 10 is electronically connected to the memory module 20 to write the graphics data in the memory module 20, and to read the graphics data from the memory module 20. Additionally, the GPU 10 converts the graphics data into scan signals and other control signals used to drive a display device of the electronic device, and provides the scan signals to the display device, to further control the display device.

The memory module 20 includes several storage blocks for storing the graphics data transmitted by the GPU 10. Usually, the greater the capacity of the graphics data, the more the storage blocks are needed. In one exemplary embodiment, the storage capacity of the memory module 20 is about 2 gigabytes (GB), and is divided into four storage blocks. The four storage blocks are respectively labeled as BANK1, BANK2, BANK3, and BANK4, and the storage capacity of each storage block is about 0.5 GB.

In one exemplary embodiment, the detection circuit 30 is an information detector. The detection circuit 30 is electronically connected to the GPU 10 to calculate a total capacity of the graphics data received by the GPU 10, and then determines a proportion of the graphics data occupying the memory module 20. For example, if the total capacity of the graphics data received by the GPU 10 is about 1.5 GB, the detection circuit 30 determines that the graphics data need to occupy about 75% of storage spaces of the memory module 20. Additionally, the detection circuit 30 is electronically connected to the controller 40 to send the proportion of the graphics that are occupying the memory module 20 to the controller 40.

In one exemplary embodiment, the controller 40 is a field programmable gate array (FPGA). The controller 40 is electronically connected to the memory module 20, and is configured to divide the memory module 20 into a first storage space and a second storage space according to the proportion of the graphics that are occupying the memory module 20 sent by the detection circuit 30. For example, if the proportion is about 75%, the controller 40 provides the first storage space including three storage blocks (BANK1, BANK2, and BANK3, for example) to the GPU 10, and then the second storage space including one storage block (e.g., BANK4) serves as an independent storage space.

In addition, the controller 40 is electronically connected to the GPU 10 to feed back the division of the memory module 20 to the GPU 10. Thus, the GPU 10 writes the graphics data in the first storage space, and reads the graphics data from the first storage space.

In one exemplary embodiment, the port 50 is a universal serial bus (USB) port. The port 50 is electronically connected to the controller 40, thus, external data can be stored in the second storage space of the memory module 20 via the port 50 and the controller 40.

In use, when the GPU 10 receives graphics data, the detection circuit 30 determines a proportion of the graphics data occupying the memory module 20, and sends the determination of the proportion to the controller 40. The controller 40 divides the memory module 20 into the first storage space and the second storage space according to the determination. Then, the controller 40 feeds back the division result to the GPU 10 to allow the GPU 10 to store the graphics data in the first storage space.

Additionally, an external device (for example, a mobile phone) can be coupled to the graphics card device 100 via the port 50, thus, external data in the external device can be stored in the second storage space of the memory module 20 via the port 50 and the controller 40. In comparing the memory module 20 with a common storage device, such as a hard disk drive (HDD), since the HDD is constrained physically by its own structure, access speed of the memory module 20 is faster.

In summary, the detection circuit 30 determines a proportion of the graphics data occupying the memory module 20, and the controller 40 divides the memory module 20 into the first storage space and the second storage space according to the determination. Then, the first storage space is used to store graphics data received by the GPU 10, and the second storage space is used to store external data transmitted from the port 50. Thus, the coefficient of utilization of the memory module 20 is improved, and the graphics card device 100 is efficient.

Although numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of disclosure to the full extent indicated by the broad general meaning of the terms in which the appended claims are expressed.

What is claimed is:

1. A graphics card device, comprising:
a memory module;
a graphic processing unit (GPU) electronically connected to the memory module, and receiving graphic data;
a controller electronically connected to the memory module and the GPU;
a detection circuit electronically connected to the GPU and the controller; and
a port electronically connected to the controller, and configured to receive external data;
wherein the detection circuit determines a proportion of the graphics data occupying the memory module, and sends the determination of the proportion to the controller, the controller divides the memory module into a first storage space and a second storage space according to the determination, the first storage space stores the graphic data received by the GPU, and the second storage space stores external data transmitted by the port.

2. The graphics card device as claimed in claim 1, wherein the controller feeds back the division of the memory module to the GPU to allow the GPU to access the first storage space.

3. The graphics card device as claimed in claim 2, wherein the GPU writes the graphics data in the first storage space, and reads the graphics data from the first storage space.

4. The graphics card device as claimed in claim 1, wherein the memory module includes several storage blocks, the controller divides the several storage blocks to allow at least one storage block to serve as the first storage space, and to allow the other storage blocks to serve as the second storage space.

5. The graphics card device as claimed in claim 1, wherein the port is a universal serial bus (USB) port.

6. The graphics card device as claimed in claim 1, wherein the controller is a field programmable gate array (FPGA).

7. The graphics card device as claimed in claim 1, wherein the detection circuit calculates a total capacity of the graphics data received by the GPU.

8. A graphics card device, comprising:
a memory module comprising several storage blocks;
a graphic processing unit (GPU) electronically connected to the memory module, and receiving graphic data;
a controller electronically connected to the memory module and the GPU;
a detection circuit electronically connected to the GPU and the controller; and
a port electronically connected to the controller, and configured to receive external data;
wherein the detection circuit determines a proportion of the graphics data occupying the memory module, and sends the determination of the proportion to the controller, the controller divides the memory module according to the determination, to allow at least one storage block to store graphic data received by the GPU, and to allow the other storage blocks to store the external data transmitted by the port.

9. The graphics card device as claimed in claim 8, wherein the controller feeds back the division of the memory module to the GPU to allow the GPU to access the at least one storage block.

10. The graphics card device as claimed in claim 9, wherein the GPU writes the graphics data in the at least one storage block, and reads the graphics data from the at least one storage block.

11. The graphics card device as claimed in claim 8, wherein the port is a universal serial bus (USB) port.

12. The graphics card device as claimed in claim 8, wherein the controller is a field programmable gate array (FPGA).

13. The graphics card device as claimed in claim 8, wherein the detection circuit calculates a total capacity of the graphics data received by the GPU.
